(19) United States
(12) Patent Application Publication
(10) Pub. No.: US 2025/0048206 A1
(43) Pub. Date: Feb. 6, 2025

(54) Method and System for Cell Measurements and Measurement Report In Fast Mobility Based on Lower Layer Signaling

(71) Applicant: ZTE Corporation, Shenzhen (CN)

(72) Inventors: Fei DONG, Shenzhen (CN); He HUANG, Shenzhen (CN); Jing LIU, Shenzhen (CN); Mengjie ZHANG, Shenzhen (CN)

(73) Assignee: ZTE Corporation, Shenzhen, GD (CN)

(21) Appl. No.: 18/920,481

(22) Filed: Oct. 18, 2024

Related U.S. Application Data
(63) Continuation of application No. PCT/CN2022/088622, filed on Apr. 22, 2022.

(51) Int. Cl. H04W 36/00

(52) U.S. Cl. CPC H04W 36/0085

(57) ABSTRACT

This disclosure is directed to UE measurements and measurement report of serving cells, and configuration for the cell measurement and report to effectuate a fast serving-cell change during UE mobility within lower network layers, such as layer-1 or layer-2 of the wireless communication protocol stack. This disclosure is further directed to signaling procedures associated with the fast serving-cell change for the UE as triggered by the network based on the cell measurement and report, and various lower layer configurations and operations for effectuating an actual fast serving-cell change at and for the UE.

### TECHNICAL FIELD

This disclosure is directed generally to mobility of wireless terminal devices and particularly to a fast serving-cell change procedure triggered by layer-1 or layer-2 signaling.

### BACKGROUND

In a cellular wireless access network, each cell may be associated with a coverage area. Coverage areas of multiple cells collectively provide wireless service to a User Equipment (UE). As the UE moves, the cells that it can connect to may vary and thus an active wireless data connection for the UE may change or switch from one cell to another cell. Such a cell change or switch may involve complex signaling and operations at various layers of the wireless communication network protocol stack of the UE and the network. It is generally preferable to minimize communication overhead and maximize communication efficiency and speed with respect to both the signaling and operation of a cell change.

### SUMMARY

This disclosure generally relates UE mobility in a wireless access network and is particularly directed to UE measurements and measurement report of serving cells, and configuration for the cell measurement and report to effectuate a fast serving cell change during UE mobility within lower network layers, such as layer-1 or layer-2 of the wireless communication protocol stack. This disclosure is further directed to signaling procedures associated with the fast serving cell change for the UE as triggered by the network based on the cell measurement and report, and various lower layer configurations and operations for effectuating an actual fast serving cell change at and for the UE.

In some implementations, a method for preparing a serving-cell change procedure performed by a wireless device is disclosed. The method may include receiving, from a wireless communication node, a cell measurement and measurement reporting configuration; performing a cell measurement based on the cell measurement and measurement reporting configuration to generate a cell measurement report associated with the cell measurement; and transmitting the cell measurement report in a cell measurement reporting message according to the cell measurement and measurement reporting configuration, the cell measurement reporting message comprising control message of layer-1 or layer-2.

In the implementations above, the layer-1 comprises a physical (PHY) layer and the layer-2 comprises at least one of a Media Access Control (MAC) layer, a Radio Link Control (RLC) layer, or a Packets Data Convergence Protocol (PDCP) layer.

In any of the implementations above, transmitting the cell measurement report may include reporting the cell measurement via a layer-1 Uplink Control Information (UCI) message or a layer-2 MAC Control Element (MAC CE) message.

In any of the implementations above, the cell measurement report may include measurement results of a source serving cell for the wireless device and at least one or more neighboring cells of the source serving cell.

In any of the implementations above, the method may further include identifying, among a set of candidate neighboring cells of the source serving cell for the wireless device, one or more suitable neighboring serving cells from preforming the cell measurement, wherein the cell measurement report comprises physical cell information of the one or more suitable neighboring cells.

In any of the implementations above, the cell measurement report may further include beam information for the one or more suitable neighboring cells, and the beam information being provided to indicate one or more recommended beams in the one or more suitable neighboring cells for the serving-cell change procedure.

In any of the implementations above, the cell measurement and measurement reporting configuration may indicate to the wireless device a triggering event condition for transmitting the cell measurement report.

In any of the implementations above, the triggering event condition for transmitting the cell measurement report may include at least one of the following set of triggering event conditions a first result of the cell measurement indicates that the source serving cell for the wireless device is continuously being at or below a first threshold measurement level during a first preconfigured measurement time period; a second result of the cell measurement indicates that at least one neighboring cell of the source serving cell for the wireless device is continuously being at or higher than a second threshold measurement level during a second preconfigured measurement time period; or a difference measurement result between the first result and the second result is continuously being at or above a cell measurement disparity threshold level.

In any of the implementations above, the first threshold measurement level may include a sum of a first preconfigured baseline threshold level and a first configurable tolerance threshold level offset.

In any of the implementations above, the second threshold measurement level may include a sum of a second preconfigured baseline threshold level and a second configurable tolerance threshold level offset.

In any of the implementations above, the cell measurement disparity threshold level may include a sum of a preconfigured baseline disparity threshold level and a configurable tolerance disparity threshold level offset.

In any of the implementations above, the first preconfigured measurement time period may encompass N consecutive measurement occasions on the source serving cell for the wireless device, N being a preconfigured positive integer.

In any of the implementations above, the second preconfigured measurement time period may encompass M consecutive measurement occasions performed on the at least one neighboring cell of the source serving cell for the wireless device, M being a preconfigured positive integer.

In any of the implementations above, the first result or the second result may include at least one of a Reference Signal Received Power (RSRP), a Signal to Interference and Noise Raton (SINR), or a Reference Signal Received Quality (RSRQ).

In any of the implementations above, the first result and the second result may each include a cell-level measurement result or a beam-level measurement result respectively associated with the source serving cell for the wireless device and the at least one neighboring cell of the source serving cell.

In any of the implementations above, the cell-level measurement result of a serving cell may be derived from measurements of multiple beams associated with the serving cell.

In any of the implementations above, the beam-level measurement result may include measurement result associated with a predetermined number of best beams of the source serving cell for the wireless device or the at least one suitable neighboring cell of the source serving cell.

In any of the implementations above, the first result may include a first consolidated N consecutive cell measurements performed on the source serving cell for the wireless device, N being a preconfigured positive integer. The second result comprises a second consolidated N consecutive cell measurements performed on the at least one neighboring cell of the source serving cell. The triggering event condition for transmitting the cell measurement report comprises transmitting the cell measurement report when a difference between the first consolidated N consecutive cell measurements and the second N consolidated consecutive cell measurements is at or above the cell measurement disparity threshold level.

In any of the implementations above, transmitting the cell measurement report in the cell measurement reporting message may include, when at least one of the set of triggering event conditions is met: transmitting a MAC CE message comprising the cell measurement report to the wireless communication node; or triggering the wireless device to transmit the cell measurement reporting message as a layer-1 Uplink Control Information (UCI) e to the wireless communication node.

In any of the implementations above, an applicable triggering event condition among the set of triggering event conditions may be configured per serving cell or for a list of candidate serving cells.

In any of the implementations above, a first neighboring cell and a second neighboring cell of the at least one neighboring cells of the source serving cell may be configured independently with different triggering event conditions among the set of triggering event conditions.

In any of the implementations above, the set of triggering event conditions may further include the wireless device detects a beam failure in the source serving cell and that fewer than P suitable beams of the source serving cell can be identified; or the wireless device detects a radio link failure with the source serving cell.

In some other implementations, a wireless device comprising a processor and a memory is disclosed. The processor may be configured to read computer code from the memory to implement any of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations or UEs and a wireless access network node in communication with one another via an over-the-air radio communication interface.

FIG. 3 shows an exemplary communication protocol stack in a wireless access network node or wireless terminal device including various network layers.

FIG. 4 illustrates a split-architecture for separating a wireless access network node into a central unit (CU) and one or more distributed units (DUs).

FIG. 5 shows an example signaling and operating flow chart for a preparation stage of a lower-layer fast serving cell change.

FIG. 6 shows an example signaling and operating flow chart for an execution stage of a lower-layer fast serving cell change.

### DETAILED DESCRIPTION

The technology and examples of implementations and/or embodiments described in this disclosure can be used to facilitate over-the-air radio resource allocation, configuration, and signaling in wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to UE measurements and measurement report of serving cells, and configuration for the cell measurement and report to effectuate a fast serving cell change during UE mobility within lower network layers, such as layer-1 or layer-2 of the wireless communication protocol stack. This disclosure is further directed to signaling procedures associated with the fast serving cell change for the UE as triggered by the network based on the cell measurement and report, and various lower layer configurations and operations for effectuating an actual fast serving cell change at and for the UE.

### Wireless Network Overview

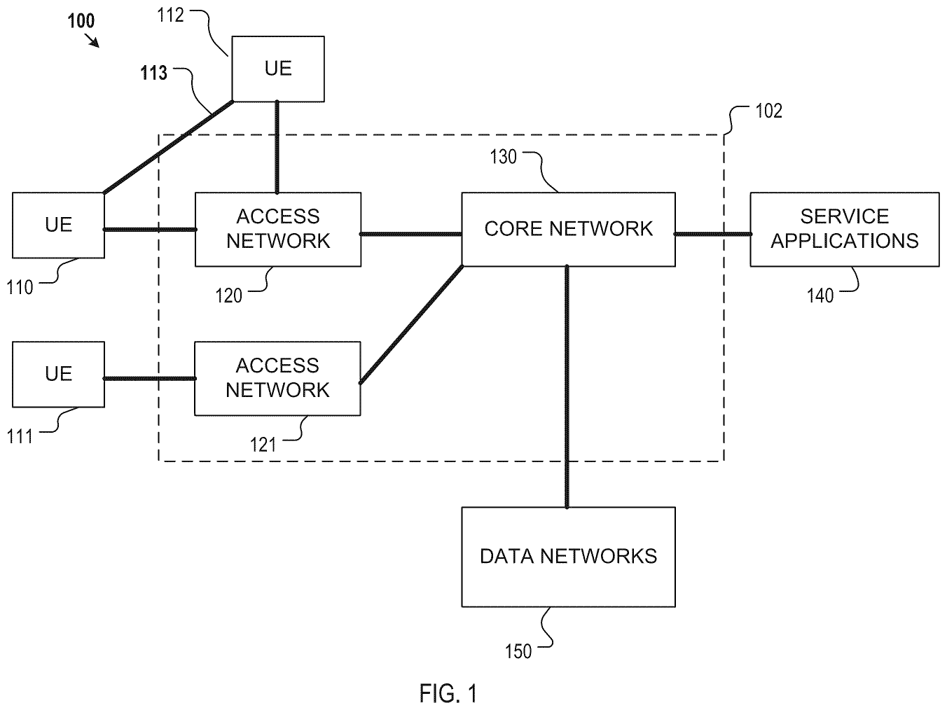

An example wireless communication network, shown as 100 in FIG. 1, may include user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

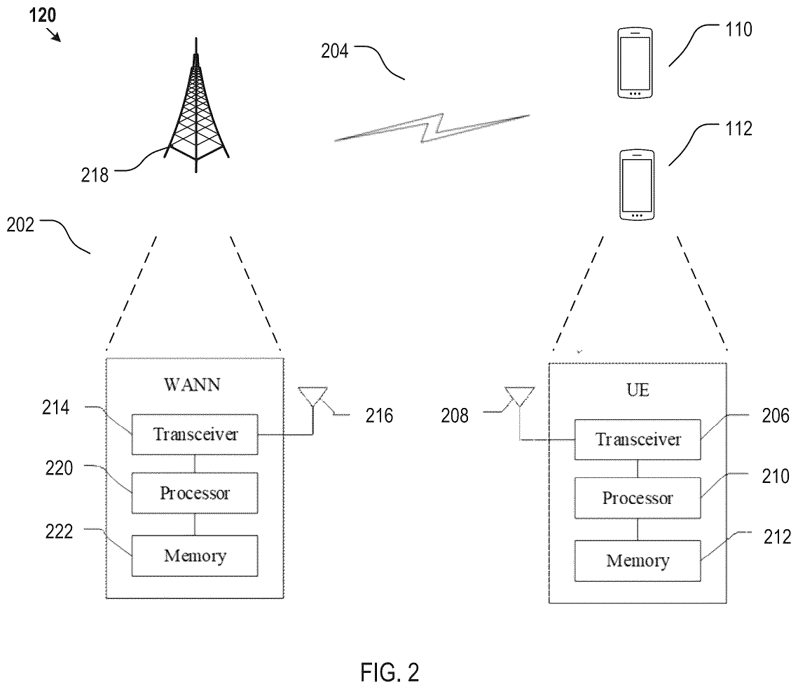

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

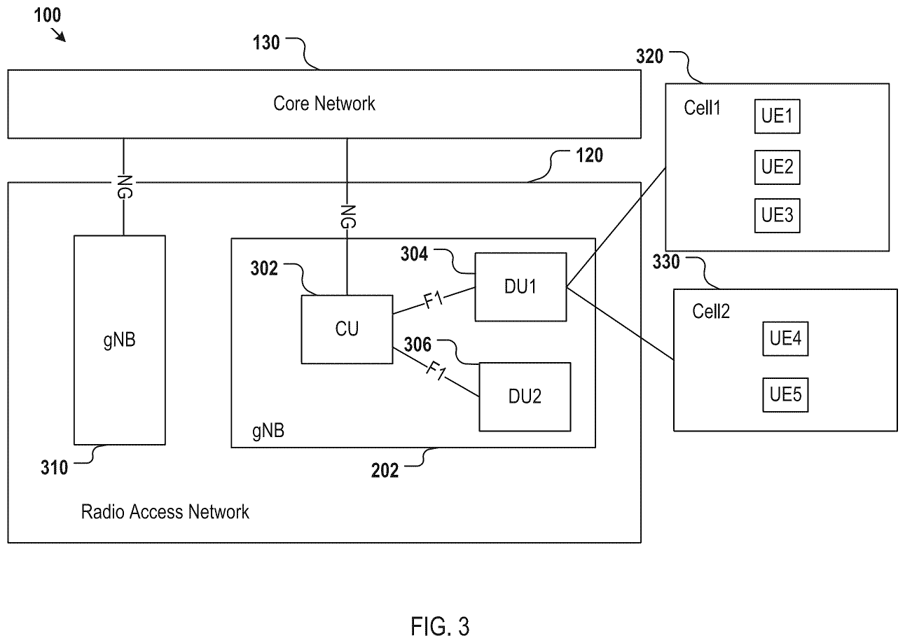

As shown in FIG. 3, the WANN 120, for example, may further include multiple separate access network nodes in the form of a Central Unit (CU) 302 and at least one Distributed Unit (DU) 304 and 306. The CU 122 may be connected with DU1 304 and DU2 306 via various F1 interface. An F1 interface, for example, may further include an F1-C interface and an F1-U interface, which may be used to carry control plane data and user plane data, respectively. The UEs may be connected to the core network 130 via the WANN 120 over a radio interface.

Each of the DUs may serve the UEs via one or more cells. Each cell is associated with a coverage area. These cells may be alternatively referred to as serving cells. The coverage areas between cells may partially overlap. Each UE may be actively communicating with at least one cell while may be potentially connected or connectable to more than one cells. In the example of FIG. 3, UE1, UE2, and UE3 may be served by cell1 320 of the DU1, whereas UE4 and UES are served by cell2 330 of the DU1. In some implementations, a UE may be served simultaneously by two or more cells. Each of the UE may be mobile and the signal strength and quality from the various cells at the UE may depend on the UE location. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as SpCell. All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

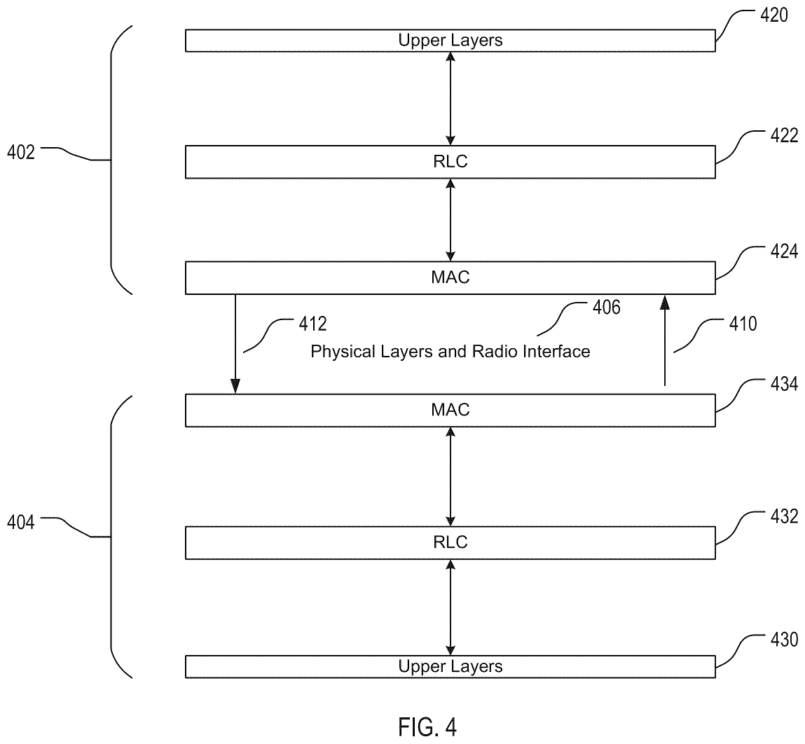

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. The term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, and/or PDCP layers/entities.

Returning to FIG. 3, the various functions of a radio access network node may be split between the CU and the DU. For example, the DUs may host low layers including L2 and L1 layers, such as RLC, MAC, and PHY (Physical) layers whereas the CU may host the high layer of the network, such as L3.

### General UE Mobility and Serving Cell Change

When the UE moves between the coverage areas of various cells, signal levels and qualities from the cells varies. The UE may be configured to measure and monitor the cell signal levels and qualities. Parameters associated with performing these measurements may be configured by the network. At some point, the signal disparity between the cells may demand serving-cell change (alternatively referred to serving cell switch, PCell and SCell role change, or serving cell handover) from a source serving cell (alternatively referred to an original serving cell) to a target serving cell for actively serving the UE. The source serving cell and the target (serving) cell may be serviced by a same DU, or by different DUs associated with the same CU, or may be serviced by different CUs. As such, serving-cell change may be intra-DU (when changing cells within the one or more cells serviced by a same DU) or inter-DU (when changing from source cell serviced by one DU to a target cell serviced by another DU). Inter-DU serving-cell change may be intra CU (when changing from a source cell to a target cell serviced by a same CU) or inter-CU (when changing from source cell serviced by one CU to a target cell serviced by another CU). These cell changes represent different levels of cell change and may involve various levels of serving-cell change configuration, resetting, and switching procedures.

In some implementations, regardless of whether the source and target serving cells are inter-CU or intra-CU, the serving cell switch may be triggered as a result of L3 measurements and may be effectuated by Radio Resource Control (RRC) signaling with synchronization. For example, RRC signaling maybe used to effectuate a change of SpCells (from one SpCell to another SpCell) (an SpCell may be a PCell or a PSCell), as well as release/add of SCells when applicable. Such SpCell change procedure initiated via RRC reconfiguration usually incurs a long interruption in user-plane data communication/flow, a significant latency in renewing user-plane data transmission, and is generally associated with considerable RRC signaling overhead.

Such high-latency RRC reconfiguration-based serving-cell change procedure from one serving cell to another may be difficult to avoid at times, particularly when the change involves source and target serving cells serviced by different CUs (inter-CU serving-cell change). However, in most cases, switching may occur from one cell to another cell serviced by the same DU (intra-DU serving-cell change), or between cells serviced by different DUs of the same CU (inter-DU but intra-CU). In these cases, the UE serving-cell change may not need to involve any change of the serving CU which hosts L3 entities. In such situations, the UE mobility only necessarily involves the non-L3 low layers in the communication protocol stack residing in the DUs, including, for example, the L1 and/or L2 layers such as the RLC/MAC/PHY layers, as shown in FIG. 3. In such situations, there is no need to require the UE to perform the serving-cell change procedure based on L3 signaling.

A serving-cell change procedure effectuated by only L1 and or L2 signaling is fast/agile, minimally affect/interrupt user-plane data flow, and helps reduce switching latency and signaling overhead. Such L1/L2-based serving cell changes may be referred to as fast serving-cell changes, and the change procedures may correspondingly be referred to as fast cell change procedure, or fast serving cell change procedure. Hyphens (“ ”) may be added between the words in these terms without modifying their meaning. In cellular networks where DU switch occurs frequently during UE mobility, e.g., when the carrier frequency of the over-the-air radio bands offers only short communication ranges and requires dense cells, the accumulative reduction in communication latency and signaling overhead would be significant.

The disclosure herein provides various example implementations of mobility measurements/reporting and the configuration and signaling thereof, the serving cell change signaling, cell change procedures, and data communication renewal as a result of the cell change, in the context of fast cell changes relying on low level signaling and operations. Such processes may provide fast, efficient, and low latency cell change with minimal user-plane data flow interruption, and may be based on L1/L2 UE mobility.

### L1/L2-Based Fast Inter-Cell Mobility in General

In general, UE mobility may be achieved by monitoring signal levels from various cells during UE movement, reporting the cell measurements to the network, executing a serving cell change procedure when certain cell switching conditions are met, and performing various procedures for renew current communication sessions. Each element of the access network, including the UEs and the WANN (or base station, herein referred as NW, representing the network side) participates collaboratively to complete the entire mobility procedures. For example, the base stations may be responsible for providing various configuration related to UE mobility, whereas the UE may be responsible for various cell measurements and reporting. The base stations rather than the UE may ultimately determine whether to perform serving cell change and whether to trigger the cell-switch so as to balance UE load serviced by both the source serving cell and a target serving cell. The target-serving cell, for example, may be determined and signaled by the NW based on the cell measurement report from the UE. In some implementations of the L1/L2 centric fast mobility, like a traditional L3-based mobility, actions on the UE side during the mobility procedures may be delineated into two stages:
Preparation Stage: including L1 and/or L3 measurement of various cells, and reporting the measurements from the UE to the NW.
Execution stage: including UE/NW behavior on each network layer when receiving the L1/L2 signaling for mobility, including the PHY layer (L1), MAC Layer, RLC layer, PDCP (L2), and RRC (L3) layer, and evaluation of the serving cell change result, and corresponding UE/NW operations following the execution of the serving cell change.

### Preparation Stage for Fast L1/L2-Based Mobility—General

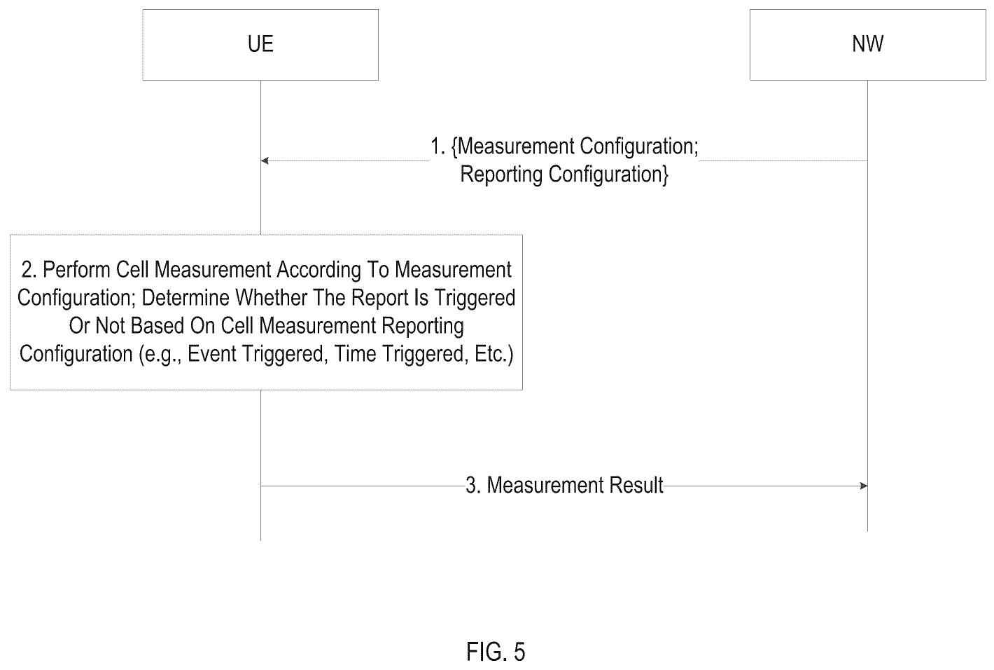

Example UE and NW (e.g., a base station) interaction during a preparation stage associated with the fast serving-cell change procedure is illustrated in the flow chart of FIG. 5. In such an example preparation stage, the general procedure may include but is not limited to:
Step 1: The NW configures the UE with cell measurement configuration and cell measurement reporting configuration.
Step 2: The UE performs cell measurement according to the received cell measurement configuration, and determines whether to trigger the measurement result report to NW based on the cell measurement reporting configuration such as pre-configured reporting conditions (e.g., time triggered conditions such as periodic, semi-persistent periodic reporting, or event triggering conditions, as described in further detail below).
Step 3: The UE reports the cell measurement results related to the source cell and one or more candidate cells neighboring the source cell to the NW if the cell measurement reporting conditions are met.

Preparation Stage for Fast L1/L2-Based Mobility—Cell Measurement Configuration and Cell Measurements

The cell measurements may be of different types, including but not limited to L3 measurements and/or L1 measurements. The measurement objects within a serving cell may include those characteristics that may be used to determine a signal quality and channel state of the cell, including but not limited to Synchronization System Block (SSB), Channel State Information Reference Signal (CSI-RS), and the like. The report timing pattern includes periodic, aperiodic, semi-persistent periodic, or at time instants when triggered by predefined or configured evens. Communication resources for transmitting the cell measurement report may include, for example, Physical Uplink Control Channel (PUCCH) resources and/or Physical Uplink Shared Channel (PUSCH) resources (in time and frequency).

For example, measurements may be performed in L1 layer on SSB and/or CSI-RS. The L1 measurements may include:
L1 measurement on the source cell that currently provide active service to the UE.
L1 measurement on one or more neighbor cells of the source cell.

In some implementations, the cell measurement configuration and the cell measurement reporting configuration may be separately signaled from the NW. In some other implementations, these configurations may be signaled to the UE as an integral signaling message. These configuration or configurations may specify measurements to be performed, contents to be reported, format for the report, reporting timing, reporting triggering conditions, reporting transmission resource allocations, and the like.

For example, the cell measurement configuration and the cell measurement reporting configuration(s) may indicate the following for, e.g., various CSI measurement:
CSI—MeasConfig, specifying a set of CSI measurement and reporting configurations for the following CSI
   CSI-ResourceConfig (e.g., periodic, aperiodic, semi-persistent periodic reporting configurations).
   NZP-CSI-RS-ResourceSet (i.e., non-zero-power CIS-RS resource set to be measured in, e.g., periodic, aperiodic, or semi-persistent periodic manner).
   CSI-RS-SSB-ResourceSet (i.e CIS-RS-SSB resources set to be measured in e.g., periodic, aperiodic, or semi-persistent periodic manner).
   CSI-ReportConfig (i.e., report triggering configuration for reporting cell measurement in periodic, aperiodic, or semi-persistent periodic manner in time, or reporting when being event triggered).

The above example cell measurement and cell measurement report configuration may be specified per cell. For example, the source cell and neighboring cells may be provided with different cell measurement and cell measurement report configurations. The neighboring cells to be measured may be configured as a list of candidate neighboring cells of the source cell for cell change. The list of candidate cells may be predetermined as a result of cell configuration in the area or may be signaled from the network. With above example implementation, both/either NZP-CSI-RS-ResourceSet and/or CSI-RS-SSB-ResourceSet may be associated with a cell indicated by PhysicalCellID or additionalPCIIndex.

### Preparation Stage for Fast L1/L2—Based Mobility-Cell Measurement Report

In some implementations, the signaling and messaging of a cell measurement report may be performed in the L1 and/or L2 layers rather than in the L3 layer. The layer(s) from which that the cell measurement report is transmitted may be predefined, preconfigured, or dynamically configured from the NW. In some example implementations, the signaling/transmission of the cell measurement report may be specified as part of the cell measurement report configuration described above. For example, the cell measurement report may be signaled/transmitted via:
L1 signaling and messaging (e.g., via uplink signaling such as Uplink Control Information (UCI), which may be transferred through PUCCH or PUSCH); and/or
L2 signaling and messaging (e.g., via a MAC CE for reporting cell measurements for service cell change procedure).

For either L1 or L2 signaling/messaging above, the measurement result that may be included in the cell measurement report may also be predefined or preconfigured, e.g., configured as specified in the cell measurement report configuration described above. The following may be signaled as optional or alternative content that may be included in a cell measurement report:
1. The direct measurement results of the source serving cell and one or more neighboring cells of the source serving cell directly, which, for example, may include at least one of the following information:
   \textcircled{1} Direct measurement result of one or more neighboring cells as potential target cell for cell change,
   \textcircled{2} Direct measurement result of the source serving cell; or
2. Identity and related information of one or more neighboring cells of the current source serving cell suitable for switching to, including, for example:
   \textcircled{1} Physical Cell Information (PCI) to indicate the one or more neighboring physical cells that are suitable as target cells for serving-cell change, as determined by the UE,
   \textcircled{1} Optionally, additional beam information for the indicated physical cell(s) to indicate beams of the suitable neighboring physical cell(s) that are suitable as serving beam for the serving-cell change.

The first alternative above may be particularly suitable for L1 signaling/messaging of a report for L1 cell measurements because L1 measurements be directly included in an L1 measurement report message without involving other higher layers. By reporting the direct measurements, via either L1 or L2 signaling/messaging, decision for determining and identifying the target serving cell for the serving-cell change may be made by the NW according to the direct measurements as reported in the cell measurement report and other factors known to the NW. The direct measurement result for either the source cell or the one or more neighboring cells may include overall measurements of the neighboring cells and the various beams within each neighboring cell.

With respect to the second alternative, a selection of suitable neighboring cells for fast serving-cell change may be made by the UE according to the direct cell measurement performed at layer-1 in the UE. The selection, for example, may be made among a set of candidate cells that are predetermined, preconfigured, or signaled from the NW, as described above. One or more of such suitable neighboring cells may be selected and reported. The NW, upon receiving the selection, may further determine the target serving cell for the fast serving-cell change.

Further with respect to the second alternative above, the physical cell information for any of the suitable neighboring cell and beam information for any of the suitable beams may be included in the cell measurement report. Such information may include but is not limited to:
Physical Cell information of a suitable neighboring cells, including, for example, at least one of:
   Physical Cell Identity,
   Location or index of the suitable cell in the candidate cell list (e.g., 0 represents the first cell information in the candidate cell information list, 1 represents the second cell information in the candidate cell information list, and so on);
Beam information for the indicated suitable physical cell, including, for example, at least one of:
   CSI-RS ID and/or SSB identifier associated with the beam,
   Beam location or index associated with a candidate beam list for a physical cell (i.e., 0 represents the first beam in the candidate beam list, and 1 represents the second beam in the candidate beam list, and so on).

In some implementations for L1 signaling/messaging, such physical cell and beam information may be reported by a code point. In some other implementations, the physical cell information and beam information may be indicated by one or more bitmaps for either L1 or L2 signaling/messaging. For example, a physical cell bitmap may be included in the cell measurement report to indicate one or more suitable neighboring cells among a set of candidate cells for serving cell change. Further, within one suitable physical cell, a beam bitmap may be included in the cell measurement report to indicate one or more beams of the physical cell considered by the UE as being suitable for the serving cell change. Other manners for indicating the above physical cell information and the beam information other than the code point or bitmaps may also be implemented for the cell measurement report.

In some other example implementations, the cell measurement report may include the combination of the two alternatives above. Specifically, the cell measurement report, either via L1 or L2 signaling/messaging, may include direct measurement results for one or more suitable neighboring cells or beams selected from the candidate cells or beams by the UE for serving-cell change.

### Preparation Stage for Fast L1/L2—Based Mobility-Cell Measurement Report by Triggering Event Conditions

In some implementations, the cell measurements may be reported to the NW according to predefined or preconfigured timing. For example, the cell measurements be reported periodically at preconfigured time slots.

In some other example implementations, the cell measurement report may be transmitted according to one or more triggering event. Whether the cell measurement report is transmitted according to time or triggering events may be pre-configured, such as being indicated in the cell measurement report configuration above.

With respect to the event-based cell measurement report, for example, the cell measurement report may be triggered at L1 or L2 by one or more of the following event conditions being met:
1: Measurement result of the source serving cell meets the following formulated condition (referred to as Bad-Source-Cell Principle (BSC)):

Measurement result of source cell≤Threshold1+Offset1 (1)
and/or
2: Measurement result of at least one of the candidate neighboring target cell meets the following formulated condition (referred to as Good-Target-Cell Principle (GTC)):

Measurement result of a candidate target cell≥Threshold2+Offset2 (2)

Meeting the BSC condition above suggests that the source serving cell may not be suitable for serving the UE and a serving cell change may be desired. Meeting the GTC condition above suggests that at least one of the neighboring serving cell may be suitable as a potential target cell to switch to. “Threshold1” above represents a baseline cell signal quality threshold for determining whether the source serving cell has become unsuitable for supporting the communication link, and “Offset2” represents a tolerance level for Threshold1. Likewise, “Threshold2” above represents a baseline cell signal quality threshold for determining whether a neighboring cell is suitable as a potential target serving cell for the serving cell change, and “Offset2” represents a tolerance level for Threshold2. Each of “Threshold1”, “Threshold2”, “Offset1”, and “Offset2” may be predetermined, preconfigured, or dynamically configured. In some example implementations, the baseline thresholds may be predefined whereas the tolerance levels may be configured.

In some situations, particularly when the UE is at a cell edge or boundary, the relative signals between the current source serving cell and one or more of the neighboring cells may fluctuate greatly. As a result, using the mechanism for determining whether the current source serving cell is bad and at least one of the neighboring cells is good based on the mechanism described above may lead to frequent serving cell change as a result of a ping-pong effect. The ping-pong effect may cause significant inefficiency and communication overhead. To avoid or reduce the ping-pong effect on L1/L2 mobility and consider the computational and signal processing capability limitation in L1/L2 layers, the following enhanced mechanism may be adopted by the UE for the event-based triggering of the transmission of cell measurement result to NW:
BSC Condition: N consecutive measurement results of the source serving cell meet the condition of Formula (1) above, and/or.
GTC condition: at the same time or following the source serving cell measurement, M consecutive measurement results of at least one neighboring cell meet the condition of Formula (2) above.

In another specific implementation for avoiding or reducing Ping-Pong effect, another enhanced mechanism may be adopted by the UE for the event-based triggering of the transmission of cell measurement result to NW
BSC Condition: The average measurement result of N consecutive measurement results of the source serving cell meet the condition of Formula (1) above, and/or
GTC condition: The average measurement results of M consecutive measurement results of at least one neighboring cell meeting the condition of Formula (2) above.

In some example implementations, the measurement results above on either the source serving cell or neighboring cells can be cell level measurement results or beam level measurement results. The cell level measurement results, for example, may be obtained from measurement results of one or more beams. The beam level measurement results, for example, may include a predetermined or preconfigured number P of best beams of a particular cell. In the implementations above, M, N and P may be predefined, preconfigured, or dynamically configured positive integers.

The N consecutive source cell measurements and the M consecutive neighboring cell measurements above correspond to a source cell measurement time window and a neighboring cell measurement time window, respectively. The enhanced mechanism above represents a filtering process that smooth out consecutive measurements more accurately represent the channel quality of the various cells to avoid or reduce the ping-pong effect.

In some example implementations, the measurement results may include one or more of Reference Signal Received Power (RSRP), Signal-to-Interference Noise Ratio (SINR), Reference Signal Received Quality (RSRQ) levels, and the like, as a reflection of channel status. When more than one results are used, the results may be aggregated or consolidated (e.g., averaged, weighted averaged, and the like), and correspondingly, the baseline threshold values and offset values above in formula (1) and (2) may also be aggregated or consolidated. Alternatively, each of the multiple measurement results for one cell may be associated with its own thresholds and offsets, thereby providing sub-conditions base on Formulae (1) and (2). Each of these formulae may be considered met when, for example, all or a majority of the sub-conditions are met.

As an example for the implementations above, the MAC layer may generate and/or transmit a MAC CE or notify L1 layer to transmit a L1 message to report the cell measurement results to the NW when it detects that a number of consecutive measurements indicating bad source cell equals to or is greater than N, and/or it detects that a number of consecutive measurements indicating of at least one of the candidate neighboring cells being a good target cell equals to or greater than M. The MAC layer thus may be configured to track the numbers of BSC and GTC measurements by using simple logic and counters, thereby not requiring the MAC layer to possess complex computational capabilities.

In some implementation of simple logic and counters, the MAC layer or entity may maintain one or two counters referred to as COUNTER A and COUNTER B. The COUNTER A may be incremented with 1 by the MAC layer or entity when receiving an indication from lower layer about the BSC, whereas the COUNTER B may be incremented with 1 by the MAC layer or entity when receiving an indication from lower layer about the GTC. With such an implementation, one or two timers may be correspondingly maintained in the MAC layer, referred to as Timer A and Timer B. The Timer A may be associated with COUNTER A, and/or the Timer B maybe associated with COUNTER B. The Timer A may be started or restarted when COUNTER A is being incremented, and Timer B may be started or restarted when COUNTER B is being incremented. The COUNTER A may be reset to 0 when Timer A expires, and the COUNTER B may be reset to 0 when the Timer B expires. In addition, one or two maximum value M and/or N for COUNTER A and COUNTER B may be preconfigured in order to trigger or transmit the cell measurement report. the cell measurement report may be triggered and/or transmitted when the COUNTER A and/or the COUNTER B reach the maximum value M and/or N.

As an example for the implementation above, the MAC layer may generate and/or transmit a MAC CE when being notified by the L1 layer to transmit a MAC CE or the L1 layer may transmit a L1 message to report the cell measurement results to the NW when L1 layer detects that an average value of more than or equal to N consecutive measurement results indicate bad source cell condition, and/or when the L1 layer detects that an average value of more than or equal to M consecutive measurement results indicating of at least one of the candidate neighboring cells is a good target cell. The MAC layer thus may be configured to track the indication from lower layer about the BSC and GTC information for generating and transmitting a MAC CE for the cell measurement report. As such, the MAC layer may trigger and/or transmit the cell measurement report when indication for BSC and/or GTC information is received from the lower layer.

In some other implementations, the event triggering condition may be based on a combination of the source cell measurement results (referred to as “first cell measurement results”) and the one or more neighboring cell measurement results (referred to as “second cell measurement results”). For example, differential results between the first cell measurement results and the second cell measurement results may be used as a basis for the triggering event for reporting the cell measurements. Specifically, an example triggering event condition may be expressed as:

Result of the neighboring cell−Result of the source cell≥Threshold3+Offset3, (3)

Where the definition or configuration of “Threshold3” and “Offset3” may be similar to those for “Threshold1”, “Threshold2”, “Offset1”, and “Offset2,” as described above.

For avoiding or reducing the ping-pong effect on L1/L2 mobility and taking into consideration the limited L1/L2 computational capability, the differential measurements above may be consecutively taken over a measurement window, and a cell measurement report may be triggered when X consecutive different measurements meet the condition above in Formula (3). In more detail for this implementation, one counter (referred to as COUNTER C) and one timer (referred to as Timer C) may be introduced in the L2 layer. For example, the COUNTER C may be associated with Timer C, and the COUNTER C may be incremented by 1 when the MAC layer receives the indication that Formula (3) is met from lower layer. The Timer C may be started or restarted as long as the COUNTER C is being incremented. The COUNTER C may be reset to 0 when the Timer C being expired. In addition, a maximum value X may be preconfigured, and the L2 layer may generate and/or transmit the cell measurement report when the COUNTER C reaches the maximum value X, and/or the L2 layer may instruct the lower layer to generate and/or transmit the cell measurement report when COUNTER C reaching the maximum value X.

In another implementation for avoiding or reducing the ping-pong effect on L1/L2 mobility and taking into consideration the limited L1/L2 computational capability, the measurement result of the neighboring cell may be an average value of Y consecutive measurements of the neighboring cell, whereas the measurement result of the source cell maybe the average value of Y consecutive measurements of the source serving cell. In detail for this implementation, the L2 layer may trigger and/or generate the cell measurement report when receiving an indication from the lower layer that Formula (3) is met, and/or L1 layer may trigger and/or generate the cell measurement report when the difference meets the formula (3).

Again, the measurements reflected in Formula (3) above may be cell level differential measurement results or the beam level differential measurement results. The cell level differential measurement results may be obtained from differential measurement results of one or more beams. The beam level measurement results, for example, may include a predetermined or preconfigured number P of best beams of a particular cell. The differential measurement results may be differential RSRP, SINR, RSRQ, and/or other differential characteristics reflecting channel status of the measured cells.

In the various implementations above for event triggered cell measurement report, the triggering event pertaining to the neighboring cells can be configured per candidate neighboring cell or per candidate neighboring cell list or per cell group.

The triggering event for different candidate cells, different candidate cell list, or different candidate cell groups may be configured differently. For example, each candidate cell, each candidate cell list, or each candidate cell group may be independently configured with their respective triggering event. For example, one neighboring candidate cell may be associated with a triggering event based on Formula (1) and (2) with filtering, whereas another neighboring candidate cell may be associated with a triggering event based on Formula (3) with filtering, or vice versa. Then, either of the neighboring cells meeting their respective triggering event would lead to a cell measurement report being sent.

In some other implementations, one or more of the following events may also trigger a cell measurement report:
BF (beam failure) on the source serving cell is detected and that fewer than P suitable beams of the source serving cell can be identified, P being a predetermined, configured positive integer number, and/or
A radio link failure is detected with respect to the source serving cells.

Meeting of these conditions suggests that the source serving cell cannot support the communication any more, and a cell switch needs to occur, and the cell measurement report as triggered would function to urge the NW to provide and specify a target serving cell for serving cell change irrespective of the quality of the target cell.

### Execution Stage—General

In some implementations, once the cell measurements are reported, the NW may then determine whether a fast serving cell change should be made for the reporting UE based on the reported cell measurements. If the decision is to proceed with effectuating the fast serving cell change, the NW may determine the target serving cell, and the execution stage of the fast serving cell change may commence.

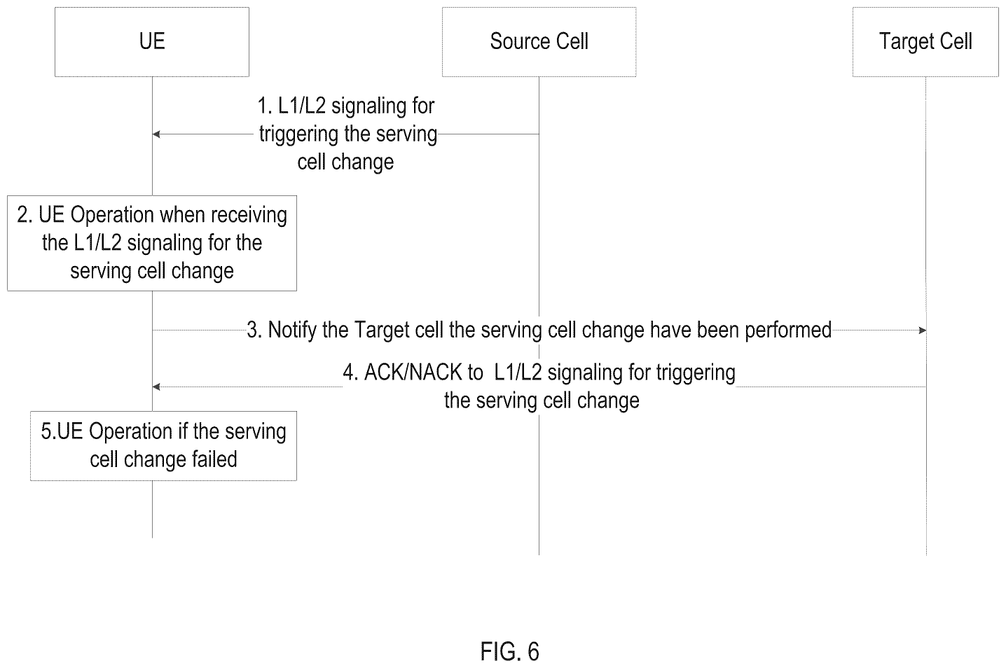

Example steps of an execution stage for the fast serving cell change is illustrated in FIG. 6. As shown in FIG. 6, these steps may include:
Step 1: The source cell transmits an L1 and/or L2 signaling message to the UE to trigger the fast serving cell change procedure.
Step 2: The UE performs a set of fast serving cell change operations.
Step 3: The UE notifies the target serving cell of the fast serving cell change.
Step 4: The target serving cell acknowledges the UE notification.
Step 5: The UE performs further operations if the fast serving cell change fails according the response or no-response from the target serving cell in Step 4.

### L1/L2 Signaling for Triggering the Fast Serving Cell Change

The fast serving cell change may be triggered by the source serving cell based on L1/L2 signaling/messaging. For example, the triggering may be entirely based on L1 signaling/messaging, such as via Downlink Control Information (DCI) message(s). In such example implementations, the L1 triggering DCI message may include at least one of a set of information items including but not limited to:
Target serving cell information:
   Physical Cell Id (PCI): to indicate the target serving cell the UE shall transfer to;
   Serving cell Id: To indicate the target serving cell the UE shall transfer to; or
   Candidate Cell ID: To indicate the target serving cell the UE shall transfer to.
Beam information: to indicate, for example, which Transmission Configuration Indicator (TCI) state can be activated for uplink and/or downlink after the UE transferring to the target serving cell. In some implementations, the beam indication may be based on CSI-RS ID and/or SSB ID. In some implementations, the beam indication may be indicated via TCI state ID. In some implementations, the Transmission Reception Point (TRP) indication can be indicated via a location of the TRP within a TRP list.
Time Advance (TA) information: to indicate a TA value of the indicated target serving cell.
Preamble index: to indicate a preamble index for the UE to perform RACH on the indicated target serving cell.
RO index: to indicate a RACH Occasion (RO) index for the UE to perform RACH on the indicated target serving cell.
Cell Radio Network Temporary Identifier (C-RNTI): to indicate a new C-RNTI for the UE when transferring to the target serving cell.
KeyCode: for the UE to verify the L1 signaling from the NW (the source serving cell). It may also be included into the RRC configuration of the indicated target serving cell indicated by physical cell information.

In some other example implementations, the triggering of the fast serving cell change procedure by the source serving cell may be entirely based on L2 signaling/messaging, such as via one or more MAC CEs. In such example implementations, the L2 triggering MAC CE may include at least one of a set of information items similar to the ones above listed for the L1 triggering DCI.

In yet some other example implementations, L1 DCI and L2 MAC CE may be used jointly for triggering the fast serving cell change procedure. For example, one or more MAC CEs may be used to activate one or more candidate cells within a candidate cell list for effectuating the fast serving cell change. Such MAC CEs may be transmitted to the one or more candidate cells for activation. MAC CEs may be further transmitted as part of the triggering to the UE to indicate to the UE which ones of the candidate serving cells are activated for fast serving cell change. In addition, one or more DCIs may be used to actually trigger the fast serving cell change to one specific target serving cell among those candidate serving cells activated by the one or more MAC CEs. In one implementation, the MAC CE for activating the candidate serving cells for fast serving cell change may include at least one of the following information:
Target Serving Cell information, which may be indicated by the physical cell identity, which may be indicated by the index of the candidate serving cell within a candidate target serving cells list.
Beam information: the beam information associated with each present target serving cell information in the same MAC CE, it may be indicated by the SSB information and/or CSI-RS information, and/or TCI state identity.

### UE Fast Serving Cell Change Operations—General

The following describes an example set of fast serving cell change operations that the UE may perform in response to receiving the L1 or L2 fast serving cell change signaling or triggering.

For example, the L2 layer of the UE may perform at least one of:
A keycode verification to verify the fast serving cell change signaling.
One or more Random Access Chanel (RACH) procedures to access the target serving cell.
One or more full MAC layer resets or adapted MAC layer resets.
One or more serving cell activation/deactivation operations

For another example, one or more RLC layer operations may also be performed in the UE. Additionally, one or more PDCP layer operations may be performed in the UE. Further, one or more RRC layer operations may be performed in the UE.

These example operations in various network layers of the UE in response to the fast serving cell change signaling are descripted in further detail below.

### UE Fast Serving Cell Change Operations-MAC Layer

In some implementations, upon receiving the fast serving cell change signaling from the source serving cell, the UE may first perform verification of keycode for the fast serving cell change. In some example implementations, if a keycode in the received L1/L2 signaling for the fast serving cell change matches a value of a reference keycode in the RRC configuration associated with the target serving cell and/or source serving cell for the fast serving-cell change, the UE may then determine that the keycode verification is successful. The UE may then proceed to notifying the upper layer about the fast serving cell change. Otherwise, the UE may ignore the received L1/L2 fast serving cell change signaling without performing further serving cell change operations.

Upon successful verification, the UE, for example may perform one or more RACH procedures to access the target serving cell. The RACH procedure, for example, may involve first determining by the UE whether any RACH operations need be performed. More specifically, the UE may determine whether to perform a RACH procedure to access the target serving cell as part of the serving-cell change procedure according to the fast-serving-cell-change signaling, and in response to determining that the RACH procedure is to be performed, proceeding with performing the RACH procedure.

In some example implementations, the RACH operations may be initiated on the target serving cell as long as the L1/L2 signaling for the fast serving cell change is received and successfully verified via the keycode procedure above.

In some alternative implementations, whether the RACH operations on the target serving cell should be initiated when receiving the L1/L2 signaling for the fast serving cell change may be determined by one or more of the following explicit indications:
an explicit RACH procedure indication pre-stored in an RRC reconfiguration message associated with the target serving cell. For example, there may be an information element in the RRC reconfiguration message indicating whether the RACH procedure is needed or not.
a presence of a RACH configuration associated with the target serving cell.
an explicit RACH trigger indication in a layer-1 or layer-2 signaling for the fast serving cell change.

The RACH operations may be performed if one or more of the above explicit conditions are met.

In some other alternative implementations, whether the RACH operations on the target serving cell should be initiated when receiving the L1/L2 signaling for the fast serving cell change may be determined by one or more of the following implicit indications:
a Time Advance (TA) value associated with the target serving cell is invalid.
absence of the TA value or a Time Advance Group (TAG) ID associated with the target serving cell.
absence of the TA value in the fast serving cell change signaling.
that a MAC reset is performed.

The RACH operations may be performed if one or more of the above implicit conditions are met.

In some example implementations, once the UE determines that the RACH procedure is to be performed on the target serving cell, it may proceed with the RACH operations. The various parameters for the RACH operations may be pre-configured in an RRC configuration associated with the target serving cell. In addition, the RACH procedure may be either a Contention-Free RACH (CFRA) procedure or a Contention-Based RACH (CBRA) procedure.

In some example implementations, when a RACH preamble identifier and/or a RACH Occasion (RO) identifier are provided by the NW via layer-1 signaling or layer-2 signaling for the fast serving cell change or RRC signaling, the UE may determine that the CFRA procedure is to be followed, and may proceed to using the RACH preamble identifier and the RO identifier explicitly provided by the NW for performing the CFRA procedure.

In some example implementations, when no RACH preamble identifier or RACH RO identifier is signaled or the present RACH preamble identifier is equal to 0b000000 or dedicated RRC configuration is not signaled, the UE may determine that the CBRA procedure is to be followed, and may proceed to selecting, amongst a plurality of Signal Blocks (SSBs), a target SSB having a Synchronization Signal-RSRP (SS-RSRP) above a reference signal received power threshold and a RACH preamble corresponding to the target SSB to perform the CBRA procedure.

In some example implementations, either a normal full MAC reset or an adapted MAC reset may be performed. The UE, for example, may first determine whether a full or adapted MAC reset is to be performed. For example, an explicit RRC information element in an RRC configuration associated with the target serving cell or a target serving cell list including the target serving cell may indicate to the UE whether to perform the normal full MCA reset or the adapted MAC reset. For another example, an explicit indication in the fast serving cell change signaling may indicate to the UE whether to perform the normal full MAC reset or the adapted MAC reset.

In some implementations, the adapted MAC rest may include performing one or more of the following:
canceling an ongoing RACH procedure;
flush a RACH Message-3 buffer;
flushing a RACH Message-A buffer;
canceling a triggered Beam Failure Recovery (BFR) procedure on the target serving cell;
cancelling a triggered Power Headroom Report (PHR) procedure on the target cell;
canceling a triggered consistent Listen-Before-Talk (LBT) failure for an original cell and the target serving cell of the wireless device;
resetting Beam Failure Instance BFI counters (BFI-COUNTERs) for the original cell and the target serving cell of the wireless device;
resetting LBT_COUNTERs for the original cell of and the target serving cell of the wireless device;
canceling a triggered Scheduling Request (SR) procedure;
flushing soft buffers for all DownLink Hybrid Automatic Repeat Request (DL HARQ) process of the original cell and considering a next received transmission of a transmission block (TB) as a first transmission; or
setting New Data Indicators (NDIs) for all UL HARQ process IDs of the original cell and the target Cell to zero.

In some implementations, the adaptive MAC reset may be a subset of a normal full MAC reset. In some implementations, some of the operations within the adaptive MAC reset may be modified from a corresponding normal MAC reset operation. In some implementation, the main difference between the full MAC reset and adaptive MAC reset may be that the full MAC reset includes considering all TA timers as expires for all time advance group (TAG) while the adapted MAC reset may not include such a consideration. Some example modifications and adaptation to the fast serving cell change are reflected in the list above for the adapted MAC reset.

In some implementations, AllowedServingCell for one LCH (e.g., DRB mapping to the serving cell) may be determined. In one implementation, if one LCH have been configured with allowedServingCells containing the target cell and the target cell is the only cell and if the target cell is one of the SCells, then UE may consider the serving cell with an ID=0 as the allowedServingCell. In one implementation, an AllowedServingCell for LCH MAC CE may be introduced to dynamically adjust the allowedServingCell for one or more LCHs. In another implementation, this MAC CE may include at least one of the following information:
LCH ID: To indicate the LCH for remapping to a serving cell.
Serving cell ID: To indicate the serving cell the LCH shall be mapped to.

In one implementation, it is up to NW to adjust the allowed serving cell for a LCH via RRC reconfiguration before sending the L1/L2 signal for serving cell change or after the serving cell change is sent to UE.

In some implementations, the MAC layer operation of the UE in response to receiving the fast serving cell change signaling may further include serving cell activation and deactivation operations. The UE may determine whether to perform any serving cell deactivation according to an indication that may be included in the fast serving cell change signaling. For example, the UE may deactivate all the activated serving cells such as SCells of a Cell group associated with the MAC entity when the L1/L2 fast serving cell change signaling is received and verified. For example, the UE may deactivate all SCells for MCG in case of PCell change, or deactivate all SCells for SCG in case that PSCell change. In some example implementations, the UE may deactivate all the activated SCells that are not included in the serving cell list indicated by an RRC information element in the RRC configuration associated with target serving cell or candidate target serving cell list.

### UE Fast Serving Cell Change Operations-RLC Layer

In some implementations, the UE may perform one or more RLC layer operations when the L1/L2 fast serving cell change signaling is received and verified. For example, the RLC layer operations may include reestablishing an RLC entity. In some implementations, whether the RLC entity is to be reestablished may be indicated by an information element in an RRC configuration associated with the target serving cell or an indication in the fast serving cell change signaling (such as a flag indicator). In some implementations, such indication information element may be per RLC entity of the involved cell group. In some other implementations, the indication information element may be configured per cell group.

### UE Fast Serving Cell Change Operations-PDCP Layer

In some implementations, the UE may perform one or more PDCP layer operations when the L1/L2 fast serving cell change signaling is received and verified.

In some implementations, when a Signal Radio Bearer (SRB) is configured with Carrier Aggregation (CA) duplication, the UE may suspend the PDCP duplication for the SRB until the serving-cell change procedure is completed. In such implementations, the PDCP entity may only generate one PDCP PDU and send it to the lower layer of the primary path.

In some implementations, when there are only two RLC entities associated with the PDCP duplication for one Data Radio Bearer (DRB), the UE may deactivate the PDCP duplication automatically when receiving the fast-serving-cell-change signaling regardless of MCG or SCG.

In some other implementations, when there are more than two RLC entities associated with the PDCP duplication for one DRB, the UE may deactivate RLC entities other than a primary RLC entity for PDCP duplication when receiving the fast-serving-cell-change signaling regardless of MCG and SCG.

In another example implementation, in the case there are more than two RLC entities associated with the PDCP duplication and RLC entities belong to different CGs, if the primary path is located in the MCG and if the L1/L2 signaling for the fast serving cell change is received for SCG, UE may deactivate the PDCP duplication for all RLC entities in the SCG. In another implementation, in the case there are more than two RLC entities associated with the PDCP duplication and RLC entities belong to different CGs, if the primary path is located in the SCG and if the L1/L2 signaling for the fast serving cell change is received for MCG, UE may deactivate the PDCP duplication for all RLC entities in the MCG.

In some implementations, a PDCP recovery may be performed by the UE. For example, an information element may be included in the RRC configuration associated with the target cell and/or candidate target cell list. The Information element may be used to indicate to the UE whether the UE needs to perform the PDCP recovery for Acknowledgement Mode (AM) DRB. If indicated, the UE may proceed to performing such PDCP recovery for the AM DRB.

### UE Fast Serving Cell Change Operations-RRC Layer

In some example implementations, the UE may perform one or more RRC layer operations when the L1/L2 fast serving cell change signaling is received and verified. The RRC layer operations may be dependent on various RRC models. Two example RRC models are described below along with corresponding RRC layer operations that the UE may perform under each of the RRC models.

### RRC Model #1

In the example RRC model #1, L1/L2 signaling-based fast serving cell change may continue using a pre-configured RRCReconfiguration message for implementing the fast serving cell change. More specifically, the UE may still follow the normal behavior of RRC reconfiguration procedure, to reuse, for example, the information element reconfigurationWithSync to implement the fast serving cell change.

In some implementations, the NW may preconfigure the UE with L1L2CentricRRCReconfig including an RRCReconfiguration message. Then the UE may store the L1L2CentricRRCReconfig information in the UE variables for L1/L2 signaling based fast serving cell change. An example RRC structure is shown as below in Table 1. In some example implementations, the keycode may be configured for the fast serving cell change in such example RRC structure.

TABLE 1

```
- L1L2CentricRRCReconfig
  - L1L2CentricRRCReconfigToADDmodList
    - L1L2CentricRRCReconfigToADDmod
    - L1L2CentricRRCReconfigID
    - KeyCode
        - L1/L2CenticRRCReconfiguration OCTET STRING
          (CONTAINING RRCReconfiguration)
  - L1L2CentricRRCReconfigToRemovList
- RRCReconfiguration
  - CellGroupConfig
    - SpCellConfig
      - ReconfigurationWithSync
      - ReconfigurationWithSync2
```

As shown in Table 1, an RRC element reoconfiguration WithSync2 may be introduced in the information element of CellGroupConfig which may be mutually exclusive with the reconfiguration WithSync.

In some implementations, if ReconfigurewithSync is received/configured in the RRCReconfiguration message for the fast serving cell change, the MAC layer may be fully reset in a normal manner and the TA value for all TAGs may be considered as invalid. In contrast, if ReconfigurewithSync2 is received/configured in the RRCReconfiguation message for the fast serving cell change, the MAC layer may be adaptively reset as described above and the TA values for the MAC entity may still be considered as valid if the corresponding TA timers are not expired.

In some implementations of ReconfigurationWithSync2, the following information elements may be further included:
SCellID/ServingCellID/AssistanceCellID/CandidateCellID/PhysicalCellID: to indicate the target cell for the fast serving cell change. In one implementation, UE may apply the cell configuration (i.e., ServingCellConfigComm and/or ServingCellConfig) associated with this information element as the serving cell configuration for the fast serving cell change.
ServingCellConfigCommon: as the Cell specific parameters for the target serving cell.
ServingCellConfig: as the UE specific parameter for the target serving cell.
New UE-ID: to indicate the new C-RNTI that shall be used after the fast serving cell change. If it is not present, the old C-RNTI shall be kept to be used when transferring to the target serving cell.

With the RRC model #1, and in some example implementations, the UE may store the current CellGroupConfiguration and/or C-RNTI and/or servingCellConfigCommon and/or servingCellConfigDedicated into candidate target cell list with the minimized L1L2CentricRRCReconfigID which is available currently when receiving the indication for the fast serving cell change from lower layer.

In some other implementations, the UE may store the current CellGroupConfiguration and/or C-RNTI and/or servingCellConfigCommon and/or servingCellConfigDedicated into candidate target cell list with the sameL1L2CentricRRCReconfigID which belongs to the target serving cell indicated by the L1/L2 signaling for the fast serving cell change.

As such, example steps below may be performed by the UE under the RRC Model #1:
STEP 1: The UE may determine whether the indication for the fast serving cell change from the lower layer is received or not, if yes, go to step 2, otherwise, go to end.
STEP 2: The UE may perform the RRC Reconfiguration procedure according to the stored RRCReconfiguration message of the target serving cell in the L1L2CentricRRCReconfigToADDmodList indicated by the indication from lower layer, then go to STEP 3.
STEP 3: The UE may store the current CellGroupConfiguration and/or C-RNTI and/or servingCellConfigCommon and/or servingCellConfigDedicated in the RRCReconfiguration Message of the source serving cell in the L1L2CentricRRCReconfigToADDmodList with the sameL1L2CentricRRCReconfigID of the target serving cell.

In another example implementations, the following steps may be performed by the UE under the RRC Model #1:
STEP 1: the UE may determine whether the reconfiguration WithSync2 or reconfiguration WithSync is included in the RRC Reconfiguration Message. If reconfiguration WithSync is included, go to step 2A, otherwise, go to step 2B.
STEP 2A: the UE may perform RRC Reconfiguration for the fast serving cell change normally (i.e., a normal full MAC reset), then go to end.
STEP 2B: the UE may perform the RRC reconfiguration for the fast serving cell change with adapted reset of the MAC entity. Then go to end.

### RRC Model #2

In the example RRC model #2, the candidate target serving cell configuration for the fast serving cell change can be within one or more cell configuration lists which may be configured within a cell group configuration CellGroupConfig and/or a cell configuration SpCellConfig.

In some example implementations, the UE may apply the delta reconfiguration of a target serving cell in the list for the fast serving cell change if the target serving cell is one of the SCells. With such implementations, the deltaConfigurationForSpCellChange information element may include at least one of the following information:
PUCCH Channel related Configuration.
NewUEIdentity.
Radio Link Monitoring related Configuration.
Beam failure Recovery related Configuration.
RACH related Configuration including:
   RACH Resource Configuration.
   Dedicated RACH resource configuration.
ResetMAC/PartialResetMAC flag.
Timer for the fast serving cell change.
KeyCode.

In some example implementations, the UE may apply the RRC configuration of a target serving cell for the fast serving cell change if the target serving cell is not one of the SCell in the SCellToAddModlist. In other words, the target serving cell cannot be activated as an SCell, and the RRC configuration of the target serving cell may include at least one of the following information:
ServingCellConfigCommon: To indicate the cell specific parameter for the target serving cell.
ServingCellConfigDedicated: to indicate the UE dedicated parameter for the target serving cell.
RACH related Configuration: to indicate the RACH resources/parameter of the target serving cell, including at least one of:
   RACH Resource Configuration.
   Dedicated RACH resource configuration.
A timer for the fast serving cell change: a timer used for UE to determine whether the fast serving cell change is successfully terminated or not.
NewUEIdentity: the C-RNTI shall be used after the fast serving cell change.
ResetMAC: to indicate whether the MAC entity shall be reset or not.
TAG ID: to indicate the TAG the target serving cell belongs to.
KeyCode.

As such, example steps below may be performed by the UE under the RRC Model #2:
Step 1: the UE may determine whether the indication of the fast serving cell change is received from lower layer or not, if yes, go to step 2. Otherwise, go to end.
Step 2: the UE may determine the RRC configuration of the target serving cell indicated by the L1/L2 signaling form lower layer is an SCell within the SCellToAddmodList, if yes, go to step 3, if not, go to step 4.
Step 3: the UE may adapt at least one of the following operations and then go to end.
   Configure the SCell in accordance with the delta configuration of the target serving cell.
   Activate the SCell, if it has not been activated.
   Release the serving cell configuration and notify the lower layer to release the resources of the current serving cell.
   Consider the SCell as the serving cell, in one implementation, consider the serving cell ID of the SCell as equal to the 0.
   Reset or adaptively reset (e.g., partially reset) the MAC entity of this cell group.
   Apply the ueNewIdentity as the C-RNTI for this cell group, if present.
Step 4: the UE may adapt at least one of the following operations and then go to end.
   Configure the lower layer for the target serving cell in accordance with the ServingCellConfigCommon, if present.
   Configure the lower layer for the target serving cell in accordance with the ServigCellConfigDedicated, if present.
   Reset or adaptively reset (e.g., partially reset) the MAC entity of this cell group.
   C Apply the ueNewIdentity as the C-RNTI for the cell group, if present.

### Notification to the Target Serving Cell

After the UE performs the various fast serving cell change operations above, it may transmit a notification of the completion of the fast serving cell change operations to the target serving cell. Such notification, for example, may be transmitted in at least one of the following formats:
MAC CE like notification including one of:
   C-RNTI MAC CE.
   BSR MAC CE.
   a NEW MAC CE which may contain the information of the UE Identity and/or keycode that is configured in the RRC configuration associated with the target serving cell/candidate target serving cell list/source cell or/and in the L1/L2 signaling for triggering the fast serving cell change.
UCI, for example, scheduling Request.
RRC Message.
RACH Procedure.

In some implementations involving MAC CEs, the Scheduling Request (SR) shall be triggered if there is no available PUSCH can be used for transferring them.

Response to the Notification from the Target Serving Cell

The response from the target serving cell to the notification above by the may include acknowledgement (ACK), or negative acknowledgement (NACK), or no response.

In some implementations, if a RACH procedure has been performed for L1/L2 signaling based the fast serving cell change, the successful termination of the RACH procedure can be considered as an ACK indication.

In some implementations, a reception of a DCI for the new C-RNTI can be considered as an ACK indication.

In some implementations, a reception of one MAC CE can be considered as an ACK indication. In this implementation, the MAC CE may only include subheader and nothing for payload or the MAC CE may include at least one of the following information:
KeyCode; or
New C-RNTI.

In some implementations, when a UL grant for a new transmission is received of which the HARQ process ID is used for sending the notification to NW, the ACK indication may be considered as being received.

In some implementations, a timer (FastServingCellChangeTimer) which is configured in the configuration associated with target serving cell and/or candidate target serving cell list and/or source serving cell may be used for determining whether the L1/L2 signaling based the fast serving cell change is successful or not. For example, if no ACK is received before the expiration of the FastServingCellChangeTimer, then the NACK indication may be deemed as being received.

### UE Action in Case of NACK to the Notification

If UE determines that a NACK is indicated from the target serving cell, the UE, for example, may trigger the RRC re-establishment procedure. For another example, the UE may revert back to the source serving cell if the source serving cell configuration is not released and/or was stored and is still available.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for preparing a serving-cell change procedure performed by a wireless device, the method comprising:
receiving, from a wireless communication node, a cell measurement and measurement reporting configuration;
performing a cell measurement based on the cell measurement and measurement reporting configuration to generate a cell measurement report associated with the cell measurement; and
transmitting the cell measurement report in a cell measurement reporting message according to the cell measurement and measurement reporting configuration, the cell measurement reporting message comprising control message of layer-1 or layer-2.

2. The method of claim 1, wherein:
the layer-1 comprises a physical (PHY) layer; and
the layer-2 comprises at least one of a Media Access Control (MAC) layer, a Radio Link Control (RLC) layer, or a Packets Data Convergence Protocol (PDCP) layer.

3. The method of claim 1, wherein transmitting the cell measurement report comprises reporting the cell measurement via a layer-1 Uplink Control Information (UCI) message or a layer-2 MAC Control Element (MAC CE) message.

4. The method of claim 3, wherein the cell measurement report comprises measurement results of a source serving cell for the wireless device and at least one or more neighboring cells of the source serving cell.

5. The method of claim 4, further comprising identifying, among a set of candidate neighboring cells of the source serving cell for the wireless device, one or more suitable neighboring serving cells from preforming the cell measurement, wherein the cell measurement report comprises physical cell information of the one or more suitable neighboring cells.

6. The method of claim 5, wherein:
the cell measurement report further comprises beam information for the one or more suitable neighboring cells; and
the beam information being provided to indicate one or more recommended beams in the one or more suitable neighboring cells for the serving-cell change procedure.

7. The method of claim 4, wherein the cell measurement and measurement reporting configuration indicates to the wireless device a triggering event condition for transmitting the cell measurement report.

8. The method of claim 7, wherein the triggering event condition for transmitting the cell measurement report comprises at least one of the following set of triggering event conditions:
a first result of the cell measurement indicates that the source serving cell for the wireless device is continuously being at or below a first threshold measurement level during a first preconfigured measurement time period;
a second result of the cell measurement indicates that at least one neighboring cell of the source serving cell for the wireless device is continuously being at or higher than a second threshold measurement level during a second preconfigured measurement time period; or
a difference measurement result between the first result and the second result is continuously being at or above a cell measurement disparity threshold level.

9. The method of claim 8, wherein the first threshold measurement level comprises a sum of a first preconfigured baseline threshold level and a first configurable tolerance threshold level offset.

10. The method of claim 8, wherein the second threshold measurement level comprises a sum of a second preconfigured baseline threshold level and a second configurable tolerance threshold level offset.

11. The method of claim 8, wherein the cell measurement disparity threshold level comprises a sum of a preconfigured baseline disparity threshold level and a configurable tolerance disparity threshold level offset.

12. The method of claim 8, wherein the first preconfigured measurement time period encompasses N consecutive measurement occasions on the source serving cell for the wireless device, N being a preconfigured positive integer.

13. The method of claim 8, wherein the second preconfigured measurement time period encompasses M consecutive measurement occasions performed on the at least one neighboring cell of the source serving cell for the wireless device, M being a preconfigured positive integer.

14. The method of claim 8, wherein the first result or the second result comprises at least one of a Reference Signal Received Power (RSRP), a Signal to Interference and Noise Raton (SINR), or a Reference Signal Received Quality (RSRQ).

15. The method of claim 8, wherein the first result and the second result each comprise a cell-level measurement result or a beam-level measurement result respectively associated with the source serving cell for the wireless device and the at least one neighboring cell of the source serving cell.

16. (canceled)

17. The method of claim 15, wherein the beam-level measurement result comprises measurement result associated with a predetermined number of best beams of the source serving cell for the wireless device or the at least one suitable neighboring cell of the source serving cell.

18. The method of claim 8, wherein:
the first result comprises a first consolidated N consecutive cell measurements performed on the source serving cell for the wireless device, N being a preconfigured positive integer;
the second result comprises a second consolidated N consecutive cell measurements performed on the at least one neighboring cell of the source serving cell; and
the triggering event condition for transmitting the cell measurement report comprises transmitting the cell measurement report when a difference between the first consolidated N consecutive cell measurements and the second N consolidated consecutive cell measurements is at or above the cell measurement disparity threshold level.

19. The method of claim 8, wherein transmitting the cell measurement report in the cell measurement reporting message comprises, when at least one of the set of triggering event conditions is met:
transmitting a MAC CE message comprising the cell measurement report to the wireless communication node; or
triggering the wireless device to transmit the cell measurement reporting message as a layer-1 Uplink Control Information (UCI) e to the wireless communication node.

20.-22. (canceled)

23. A wireless device comprising a processor and a memory, wherein the processor is configured to read computer code from the memory to cause the wireless device to:
receive, from a wireless communication node, a cell measurement and measurement reporting configuration;
perform a cell measurement based on the cell measurement and measurement reporting configuration to generate a cell measurement report associated with the cell measurement; and
transmit the cell measurement report in a cell measurement reporting message according to the cell measurement and measurement reporting configuration, the cell measurement reporting message comprising control message of layer-1 or layer-2.

24. A computer program product comprising a non-transitory computer-readable program medium with computer code stored thereupon, the computer code, when executed by a processor, causing the processor to:
receive, from a wireless communication node, a cell measurement and measurement reporting configuration;
perform a cell measurement based on the cell measurement and measurement reporting configuration to generate a cell measurement report associated with the cell measurement; and
transmit the cell measurement report in a cell measurement reporting message according to the cell measurement and measurement reporting configuration, the cell measurement reporting message comprising control message of layer-1 or layer-2.
